(19) United States
(12) Patent Application Publication
(10) Pub. No.: US 2015/0343350 A1
(43) Pub. Date: Dec. 3, 2015

(54) SPLIT FILTER BLOCK FOR EXTRUDER PRESS

(71) Applicants: Christopher Bruce BRADT, LaSalle (CA); Richard Romeo LEHOUX, Windsor (CA); Jouko KOPONEN, Kirkland (CA); Dave SALT, Mississauga (CA)

(72) Inventors: Christopher Bruce BRADT, LaSalle (CA); Richard Romeo LEHOUX, Windsor (CA); Jouko KOPONEN, Kirkland (CA); Dave SALT, Mississauga (CA)

(21) Appl. No.: 14/725,209

(22) Filed: May 29, 2015

Related U.S. Application Data
(60) Provisional application No. 62/005,351, filed on May 30, 2014.

(51) Int. Cl. B01D 35/30; B01D 35/02; B01D 25/02; B01D 29/56

(52) U.S. Cl. CPC B01D 35/30; B01D 29/56; B01D 35/02; B01D 25/02

(57) ABSTRACT

A solid/fluid separation module and apparatus enables treatment of solids with enclosed fluids to generate a filtered mass having a solids content above 50%. A split filter module with first and second filter blocks clamped together for forming barrel sections or filtering sections is disclosed for use in a solid/fluid separating device including a barrel and a conveyor screw in the barrel. The split filter module permits replacement, maintenance, or repair of the filter blocks without disassembly or the separating device, or removal of the conveyor screws.

### CROSS REFERENCE TO RELATED APPLICATIONS

The present application claims priority from U.S. Provisional Application Ser. No. 62/005,351, filed May 30, 2014 and entitled Split Filter Block For Extruder Press, the disclosure of which is incorporated herein in its entirety.

### FIELD OF THE INVENTION

The present disclosure is broadly concerned with solid/fluid separation apparatus and methods for the separation of different types of solid/fluid mixtures. In addition, the present disclosure relates to rotary presses, in particular improved screw press devices, which can be used for the separation of a wide variety of solid/fluid mixtures.

### BACKGROUND OF THE INVENTION

Various processes for the treatment of solid/fluid mixtures by solid/fluid separation are known. They generally require significant residence time and high pressure and, at times, high temperature. Conventional solid/fluid separation equipment is not satisfactory for the achievement of high solid/fluid separation rates and for separated solids with low liquid content.

Processes including the washing and subsequent concentration of a liquid slurry under pressure require solid/liquid separation equipment able to operate under pressure without clogging. For example, a key component of process efficiency in the pretreatment of lignocellulosic biomass is the ability to wash and squeeze hydrolyzed hemi-cellulose sugars, toxins, inhibitors and/or other extractives from the solid biomass/cellulose fraction. It is difficult with conventional equipment to effectively separate solids from liquid under the high heat and pressure required for cellulose pre-treatment.

Many biomass-to-ethanol processes generate a wet fiber slurry from which dissolved compounds, gases and liquids must be separated at various process steps to isolate a solids and/or fibrous portion. Solid/fluid separation is generally done by filtration and either in batch operation, with filter presses, or continuously by way of rotary presses, such as screw presses.

Solid/fluid or solid/liquid separation is also necessary in many other commercial processes, such as food processing (oil extraction), reduction of waste stream volume in wet extraction processes, dewatering processes, or suspended solids removal.

Commercially available screw presses can be used to remove moisture from a solid/liquid slurry. The de-liquefied solids cake achievable with conventional presses generally contains only 40-50% solids, the leftover moisture being predominantly water. This level of separation may be satisfactory when the filtration step is followed by another dilution or treatment step, but not when maximum dewatering of the slurry is desired. The unsatisfactory low solids content is due to the relatively low maximum pressure a conventional screw press can handle, which is generally not more than about 100-150 psig of separation pressure. Commercial Modular Screw Devices (MSDs) combined with drainer screws can be used, which can run at higher pressures of up to 300 psi. However, their drawbacks are their inherent cost, complexity and continued filter cake limitation of no more than 50% solids content.

During solid/fluid separation, the amount of liquid remaining in the solid fraction is dependent on the amount of separating pressure applied, the thickness of the solids cake, and the porosity of the filter. The porosity of the filter is dependent on the number and size of the filter pores. A reduction in pressure, an increase in cake thickness, or a decrease in porosity of the filter, will all result in a decrease in the degree of liquid/solid separation and the ultimate degree of dryness of the solids fraction.

For a particular solids cake thickness and filter porosity, maximum separation is achieved at the highest separating pressure possible. Moreover, for a particular solids cake thickness and separating pressure, maximum separation is dependent solely on the pore size of the filter.

High separating pressures unfortunately require strong filter media, which are able to withstand the separating pressure within the press, making control of the filtering process difficult and the required equipment very costly. Filter media in MSDs are generally in the form of perforated pressure jackets. The higher the separating pressures used, the stronger (thicker) the filter media (pressure jacket) need to be in order to withstand those pressures. The thicker the pressure jacket, the longer the drainage perforations, the higher the flow resistance through the perforations. Thus, in order to achieve with high-pressure jackets (thick jackets) the same filter flow-through capacity as with low-pressure jackets (thin jackets), the number of perforations should be increased. However, increasing the number of perforations weakens the pressure jacket, once again reducing the pressure capacity of the filter unit. Another approach to overcome the higher flow resistance with longer perforations is to increase the diameter of the perforations. However, this will limit the capacity of the filter to retain small solids, or may lead to increased clogging problems. Thus, the acceptable pore size of the filter is limited by the size of the fibers and particles in the solids fraction. The clarity of the liquid fraction is limited solely by the pore size of the filter media and pores that are too large reduce the liquid/solid separation efficiency and potentially lead to plugging of downstream equipment.

Over time, filter media tend to plug with suspended solids, reducing their production rate. This is true especially at the high pressures required for cellulose pre-treatment. Thus, a backwash liquid flow is normally required to clear any blockage and restore the production rate. Once a filter becomes plugged, it takes high pressure to backwash the media. This is particularly problematic when working with filter media operating at pressures above 1000 psig with a process that is to be continuous to maximize the production rate, for example to obtain high cellulose pre-treatment process efficiency.

Conventional single, twin, or triple screw extruders do not have the residence time necessary for low energy pre-treatment of biomass, and also do not have useful and efficient solid/fluid separating devices for the pre-treatment of biomass. U.S. Pat. No. 3,230,865 and U.S. Pat. No. 7,347,140 disclose screw presses with a perforated casing. Operating pressures of such a screw press are low, due to the low strength of the perforated casing. U.S. Pat. No. 5,515,776 discloses a worm press having drainage perforations in the press jacket, which increase in cross-sectional area in flow direction of the drained liquid. U.S. Pat. No. 7,357,074 is directed to a screw press with a conical dewatering housing with a plurality of perforations for the drainage of water from bulk solids compressed in the press. Again, a perforated casing or jacket is used. As will be readily understood, the higher the number of perforations in the housing, the lower the pressure resistance of the housing. Moreover, drilling perforations in a housing or press jacket is associated with serious challenges when very small apertures are desired for the separation of fine solids.

Published U.S. Application US 2012/0118517 discloses a solid/fluid separation module with high porosity for use in a high internal pressure press device for solid/fluid separation at elevated pressures. The filter module includes filter packs respectively made of a pair of plates that create a drainage system. A filter plate with cut through slots creates flow channels for the liquid to be removed and a backer plate creates a drainage passage for the liquid in the flow channels. Moreover, the backer plate provides the structural support for containing the internal pressure of the solids in the press during the squeezing action. The filter pore size is adjusted by the thickness of the filter plate and/or the opening width of the slots in the filter plate. To minimize pore size, both the filter plate thickness and the drainage slot width are minimized. However, in this separation module, as well as in all the other conventional separation devices discussed above, backwashing of a clogged separation module or filter may not be sufficient to achieve release of clogged matter or full removal of all matter clogging the separation module or filter. The separation equipment must then be disassembled for a through cleaning of the separation module or filter. However, this disassembly is very time consuming and often requires the removal and installation of the conveyor screws, especially when separation modules with filter plates are used. Thus, an improved solid/fluid separation device is desired.

### SUMMARY OF THE INVENTION

It is an object of the present invention to obviate or mitigate at least one disadvantage of previous solid/liquid separation devices and processes.

In order to improve the operation and maintenance of a solids/fluid separation device, the invention provides a solid/fluid separation module with a split filter unit for separating fluid from a solid/fluid mixture. The module can be incorporated into a solid/fluid separation device, such as a modular screw device or a screw extruder and allows for assembly or removal of the filter unit without disassembly of the device, in particular without removal of the screw or extruder screw. The module may be used, for example, in a large bore screw extruder and, for example, for compressing the solid/fluid mixture at pressures above 300 psig.

To achieve improved operating flexibility at reduced maintenance cost, the solid/fluid separation module of the invention preferably requires only the stopping of the screw rotation for replacement of the filter block without any disassembly of any part other than the separation module. This is achieved by a split filter unit in accordance with the invention including first and second filter blocks joinable along a longitudinal plane of symmetry of the core passage of the extruder screw, for defining the core passage when joined along the plane of symmetry. The filter blocks are sealably mountable in the housing so that the housing and joined filter sections together define the longitudinal portion of the core passage. At least one of the filter blocks is a stacked block including a plurality of barrel plates having flat front and back surfaces, an inner edge located at the core opening and an outer edge for contact with a fluid collection chamber in the separation module. The plurality of barrel plates are sealingly stacked in a plate stack one behind the other. At least one of the first and second filter blocks includes a filter passage extending from the inner edge to the outer edge.

In a variant embodiment, the separation module includes a filter unit made of a stack of barrel plates which each have a central bore for receiving the extruder screw and are each split into first and second sections along a separation plane extending across a line of symmetry of the central bore. When the barrel plates are stacked into the filter block, the division of the barrel plates into the first and second plate sections leads to a division of the filter block along the separation plane into first and second filter blocks which can be placed about the conveyor screw.

In either embodiment, each filter block including stacked plates also includes a stacking structure for aligning the stacked plates or stacked plate sections and for combining them into the filter blocks. The separation module further includes a clamping structure for clamping the first and second filter blocks about the conveyor screw to form a clamped filter block enclosing the extruder screw and sealing the bore along the separation plane. At least one of the stacked barrel plates is constructed as a filter plate defining a filter passage for liquid to drain away from the central bore.

In addition to the split block filter unit, a separation module in accordance with the invention includes a housing for integration into the barrel of a screw extruder, the housing defining a pressurizable fluid collection chamber for housing the clamped filter block. The housing has opposite lids which are removable while the housing is incorporated into the barrel. The removable lids allow access to and removal of the clamping structure and the first and second filter blocks from the housing. The housing preferably further includes a sealing and compressing structure for movement between an open position wherein the filter blocks can be removed from the housing, to a locked position in which the compressing structure engages and compresses the filter blocks for locking the clamped filter block in the housing and for sealing of the core passage defined by the clamped filter block from the collection chamber.

For removal of the filter unit from the extruder, the opposing lids are removed from the housing, the compressing structure is moved into the open position and the clamping structure is removed from the clamped filter block to allow removal of the first and second filter blocks from the housing. The installation of replacement filter blocks, different filter blocks, or the same filter blocks after cleaning is then achieved in reverse order. A seal is preferably inserted between the first and second filter blocks in the separation plane for improved sealing of the central bore and further seals are preferably provided between the compressing structure and the clamped block and between the housing and the removable lids.

The filter passages can be formed directly in the filter plate by cutting filter slots into the filter plate, or by simply recessing a fluid passage into a surface of the filter plate. This can be achieved much more easily than the conventional approach of drilling holes in a pressure jacket. For example, a recessed filter passage can be produced by etching the passage into the filter plate surface. By only recessing the filter passage into a surface of the filter plate, the overall integrity of the filter plate is affected less than in filter plates having cut through filter slots. Using recessed passages allows for the creation of much smaller filter pores by using very narrow and shallow passages. For example, by cutting a filter passage of 0.01 inch width and 0.001 inch depth into the filter plate, a pore size of only 0.00001 square inch can be achieved (smallest depth of passage*smallest width of passage).

In one embodiment, the first and/or second filter block includes a plurality of stacked barrel plates, each having a flat front face, a flat rear face, an inner edge defining the core opening and extending from the front face to the rear face and an outer edge for contact with the collection chamber. The barrel plates are stacked in the filter unit one behind the other for sealing engagement of the front and rear faces of adjacent barrel plates to form the filter block and to seal the core opening from the fluid collection chamber in the clamped block. At least one of the barrel plates is constructed as a filter plate having a filter passage recessed into the front face, the filter passage extending from the inner edge to the outer edge for draining fluid in the core opening to the collection chamber in the installed condition of the filter block.

In another embodiment, at least two adjacent barrel plates are together constructed to form a filter plate pair in which one functions as the filter plate and includes one or more filter slots cut through the filter place at the inner edge, while the other functions as a backer plate providing a fluid drainage passage from the filter slots to the outer edge.

In still a further embodiment, a large number, or the majority, of the barrel plates in at least one of the filter blocks are constructed as a filter plate. To achieve the highest possible porosity, each barrel plate may be constructed as a filter plate.

In the filter unit of the invention, each filter plate, or filter plate pair includes at least one filter passage. To increase filter porosity, each filter plate can include multiple filter passages. The number of the filter passages in each filter plate or filter plate pair may be chosen to maximize porosity without compromising filter plate or filter block integrity.

In one aspect, the invention provides a filter unit for a solid/fluid separating press with at least one conveyor screw for conveying a solid/fluid mixture, the press having a barrel divided into at least two barrel modules respectively defining a longitudinal portion of a core passage for housing the at least one conveyor screw. At least one of the barrel modules is a filter module having a housing defining a fluid collection chamber. The filter unit includes first and second filter blocks joinable along a longitudinal plane of symmetry of the core passage for defining the core passage when joined along the plane of symmetry. The filter blocks are sealably mountable in the housing for the housing and joined filter sections together defining the longitudinal portion of the core passage. At least one of the filter blocks is a stacked block including a plurality of barrel plates having flat front and back surfaces, an inner edge located at the core opening and an outer edge for contact with the collection chamber. In the stacked block, the barrel plates are sealingly stacked in a plate stack one behind the other. At least one of the filter blocks includes a filter passage extending from the inner edge to the outer edge.

In one embodiment, at least one of the barrel plates is constructed as a filter plate and includes the filter passage. The filter passage may be in the front and/or back surface.

In another embodiment, at least one pair of the barrel plates is constructed as a filter plate pair defining the filter passage.

The filter unit of the invention can be used with a solid/fluid separating press including one or two conveyor screws, wherein when more than one conveyor screw is used, the plane of symmetry of the core passage along which the filter blocks are joined extends through a longitudinal axis of each conveyor screw.

One or both of the first and second filter blocks may be a stacked block. Alternatively, one filter block may be a solid block, while the other filter block is a stacked block.

In the filter unit of the invention, the stacked block may include the stack of barrel plates and/or filter plates and a pair of end plates, the plate stack being compressed between a pair of end plates. The stacked block may also include a stacking structure for aligning the barrel/filter plates in the plate stack and for compressing the plate stack into the stacked block in which the barrel plates are stacked one behind the other and between the end plates.

The filter unit of the invention may further include a clamping structure for clamping the first and second filter blocks together along the plane of symmetry to form a clamped block, defining a portion of the core passage.

Each filter plate, or filter plate pair, can have a preselected pore size, whereby each filter passage has an opening area at the inner edge corresponding to the preselected pore size. Moreover, each plate stack may have a preselected filter pore size and a preselected porosity, whereby each filter passage has an opening area at the inner edge corresponding to the preselected pore size and each filter plate, or filter plate pair, has a plate porosity calculated from a total surface of the core opening, the preselected pore size and the number of filter passages. The plate stack then includes a number of filter plates, or filter plate pairs at least equal to the ratio of preselected porosity/plate porosity.

In another aspect, the invention provides a filter unit for a solid/fluid separating press with at least one conveyor screw for conveying a solid/fluid mixture and a barrel divided into at least two barrel modules respectively defining a longitudinal portion of a core passage for housing the at least one conveyor screw, at least one of the barrel modules being a filter module having a housing defining a fluid collection chamber. The filter unit includes a plurality of barrel plates having flat front and back surfaces, an inner edge defining a core opening of a size and shape equal to the core passage and an outer edge. To allow for disassembly of the filter unit, each barrel plate is divided into first and second split plates along a plane of symmetry of the core passage. This filter unit further includes a stacking structure for aligning the first split plates into a first plate stack and the second split plates into a second plate stack, wherein the first and second split plates are stacked one behind the other in the first and second plate stack respectively, and for compressing the first and second plate stacks into first and second filter blocks wherein the first and second split plates are sealingly engaged with one another in their respective plate stack. This filter unit further includes a clamping structure for clamping the first and second filter blocks together along the plane of symmetry to form a portion of the core passage and a portion of the barrel. At least one of the first and second split plates in at least one of the first and second plate stacks defines a filter passage extending from the inner edge to the outer edge.

In still a further aspect, the invention provides a solid/fluid separating module for a solid/fluid separating press including at least one conveyor screw for conveying a solid/fluid mixture and a barrel defining a core passage for the at least one conveyor screw, the core passage having a longitudinal axis for each extruder screw. The separating module includes a housing for integration into the extruder barrel and for defining a pressurizable fluid collection chamber, the housing having a pair of opposite lids removable from the housing when integrated into the extruder barrel. The module further includes a filter unit in accordance with the invention, which filter unit is sealingly mounted in the housing for sealing the core opening from the collection chamber. In one embodiment of the solid/fluid separating module, the housing includes separate drains for liquids and gases.

In yet another aspect, the invention provides a solid/fluid separating press including at least one conveyor screw for conveying a solid/fluid containing mixture and a barrel defining a core passage for the at least one extruder screw, the core passage having a longitudinal axis for each extruder screw, the barrel including at least two barrel modules of which at least one is a solid/fluid separating module in accordance with the invention. In one embodiment of the solid/fluid separating press, all barrel modules are solid/fluid separating modules in accordance with the invention. In another embodiment, each solid/fluid separating module has a preselected pore size and each filter passage has an opening area at the inner edge corresponding to the preselected pore size. The filter module may have a preselected porosity calculated from a total surface of the core opening divided by the preselected pore size and the number of filter passages in the filter blocks.

In still another aspect, the invention provides a use of the solid/fluid separating press in accordance of the invention for separating fluids from a solid/fluid containing mixture, for example biomass, such as lignocellulosic biomass.

The separation module in accordance with the invention in one embodiment includes a filter unit having a porosity of 5% to 20% (total pore area relative to the total filter surface) and is constructed to withstand operating pressures of 300 psig to 10,000 psig, at a filter porosity of 5 to 20%, or 11 to 20%. Each filter plate may include a plurality of filter passages with a pore size of 0.0005 to 0.00001 square inch.

In another embodiment, the filter unit includes filter pates with passages having a pore size of 0.00001 square inch for the separation of fine solids, a porosity of 5.7% and a pressure resistance of 2,500 psig. In still another embodiment, the filter unit includes pores having a pore size of 0.0005 square inch and a porosity of 20% and a pressure resistance of 5,000 psig. In a further embodiment, the filter unit includes pores of a pore size of 0.00005 square inch and a porosity of 11.4%. In still a further embodiment, the filter unit includes pores having a pore size of 0.00001 square inch and a porosity of 20%.

In the filter unit in accordance with the invention, the pore size can be controlled by varying either one or both of the width and depth of the filter passages. To maintain maximum filter plate integrity, the depth of the filter passage can be maintained as small as possible and pore size controlled by varying the filter passage width. The width of the filter passages may vary from 0.1 inch to 0.01 inch and the depth of the filter passages may vary from 0.001 inch to 0.005 inch. The filter passages in a filter plate may all have the same pore size, or may have different pore sizes.

In the solid/fluid separation press in accordance with the invention, the separation module is mounted to the barrel of the press and the core opening is sized to fittingly receive a longitudinal portion of the extruder screw, or screws, of the press. The conveyor screw preferably has close tolerances to the central bore of the clamped filter block for continually scraping the compressed material away from the filter surface while at the same time generating a significant separating pressure. In the event that a small amount of fibers become trapped on the surface of the filter blocks, the fibers will be sheared by the conveyor screw into smaller pieces and ultimately pass through the filter unit and out with the liquid stream as very fine particles. This provides a solid/fluid separation device, which allows for the separation of solid and liquid portions of a solid/fluid mixture in a high pressure and high temperature environment.

In a further embodiment of the solid/fluid separation press, the press includes twin, intermeshing conveyor screws, the separation module is mounted to the barrel of the twin screw press and the central bore is sized to fittingly receive a portion of the intermeshing conveyor screws. The housing may have separate liquid and gas outlets for separately draining liquids and gases from the collection chamber.

Other aspects and features of the present disclosure will become apparent to those ordinarily skilled in the art upon review of the following description of specific embodiments in conjunction with the accompanying figures.

### BRIEF DESCRIPTION OF THE DRAWINGS

For a better understanding of the embodiments described herein, and to show more clearly how they may be carried into effect, reference will now be made, by way of example only, to the accompanying drawings which show the exemplary embodiments and in which:

FIG. 1 is a partially schematic side elevational view of an exemplary solid/fluid separating apparatus including a pair of solid/fluid separation modules in accordance with the invention;

FIG. 2 is a perspective view of an exemplary solid/fluid separation module;

FIG. 3 illustrates the solid/fluid separation module of FIG. 2 in exploded view;

FIG. 4 shows a vertical cross-section through the solid/fluid separation module of FIG. 2;

FIG. 5 is a partial cut-away view of the solid/fluid separation module of FIG. 2;

FIG. 6 is a perspective view of an exemplary split filter module in accordance with the invention;

FIG. 7 is a perspective view of a lower filter plate stack of the split filter module of FIG. 6;

FIG. 8 is a perspective view of an upper filter plate stack of the split filter module of FIG. 6;

FIG. 9 illustrates the upper filter plate stack of FIG. 8 in exploded view; and

FIG. 10 is an axial plan view of an exemplary filter plate for inclusion in the upper or lower filter plate stack of FIG. 7 or 8.

### DETAILED DESCRIPTION OF THE PREFERRED EMBODIMENTS

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The filter unit of the invention is intended for use with a single screw, twin screw or multi-screw solid/fluid separation press, for example a twin screw extruder assembly having parallel or non-parallel screws with the flighting of the screws intercalated or intermeshed at least along a part of the length of the extruder barrel to define close-clearance spaces between the screws and between each screw and the barrel. However, the filter unit of the invention can also be used with screw extruders having more than two conveyor screws.

The inventors developed a split filter unit for a solid/fluid separating device, or a solid/fluid filtering device for use with a solid/fluid separating device or press, for example a screw press conveyor, or a modular screw device, which filtering device can be installed into and/or removed from the solid/fluid separating device or press without requiring disassembly of the separating device, any assembly or disassembly being limited to a separating module of the separating device, which separating module houses the filter unit. In particular, the filter unit of the invention can be installed or removed from the separating module without removal of the conveyor screw from the separating device.

In addition to this advantage, the filter unit of the invention can include a barrel plate stack filter able to handle very high pressures (up to 20,000 psig). Some or all of the barrel plates can be constructed as filter plates to create a filer plate stack able to generate solids levels from 50-90%, well beyond that of commercially available screw press filtering devices. The filter plate stack can provide the further advantage of a very small pore size filter, so that a liquid portion extracted with this filter can contain little suspended solids. The combination of a high pressure filter unit in accordance with the invention with a twin-screw extruder press can result in a solid/liquid separation device capable of developing virtually dry cake of a solids level above 80%. A twin conveyor screw press in accordance with the invention and including a filter unit in accordance with the invention can process a solid/fluid mixture in a thin layer at pressures exceeding 300 psi while at the same time allowing trapped and bound liquid and water a path to migrate out of the mixture through the filter unit.

Using a screw press or extruder press with a filter unit in accordance with the invention, one can apply significant shear forces/stresses to a solid/fluid mixture, which forces are applied in a thin cake to free up liquid to migrate out through the filter unit. Most importantly, the filter unit is a split block filter unit, which can be installed about the conveyor screw or screws so that disassembly of the screw press, namely removal of the conveyor screw or screws is no longer required for assembly and disassembly of the filter unit. Thus, this split block filter unit when used with a twin-screw extruder press will provide significant benefits by reducing the amount of downtime and repair cost associated with cleaning a clogged filter unit.

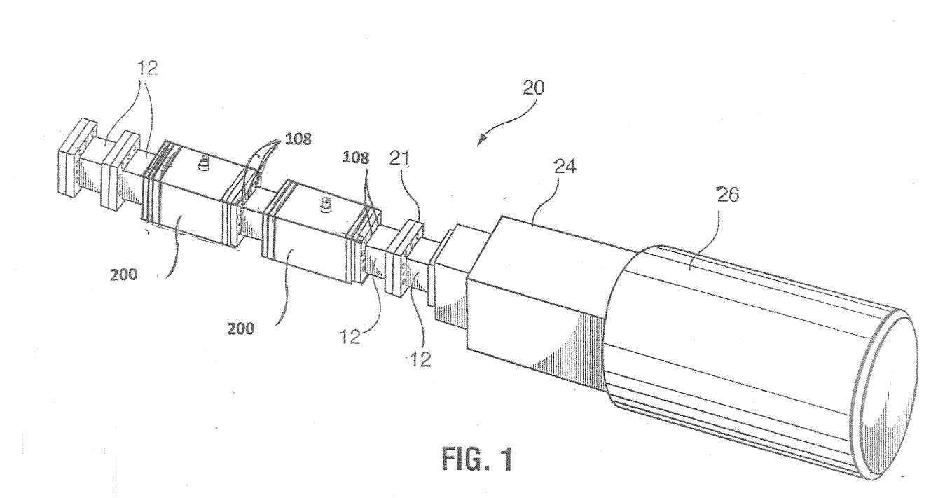

Turning now to the drawings, FIG. 1 schematically illustrates an exemplary solid/fluid separating apparatus 20 including separating modules 200 with split block filter units in accordance with the invention. The exemplary apparatus is a twin-screw extruder including a barrel 21 with barrel modules 12 and separation modules 200. The extruder is driven by a motor 26 through an intermediate gear box drive 24, both the motor and gear box being conventional components. Although the separation modules in the illustrated exemplary embodiment are shown to have a larger axial length than the barrel modules 12, in another embodiment, the axial length of the separation modules 200 can be adjusted to be identical to that of the barrel modules 12, to allow for swapping of the barrel modules with the separation modules and vice versa. The separation modules 200, including split filter units in accordance with the invention, will now be described in more detail in the following.

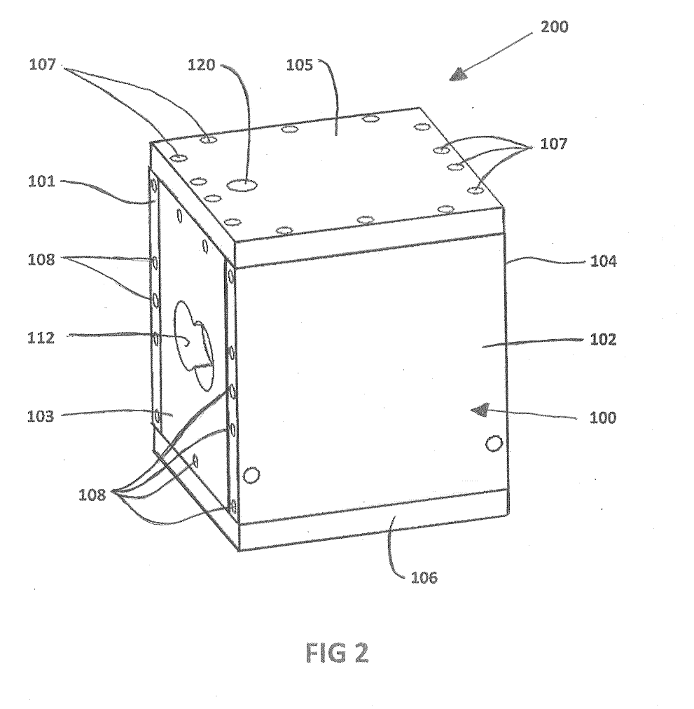

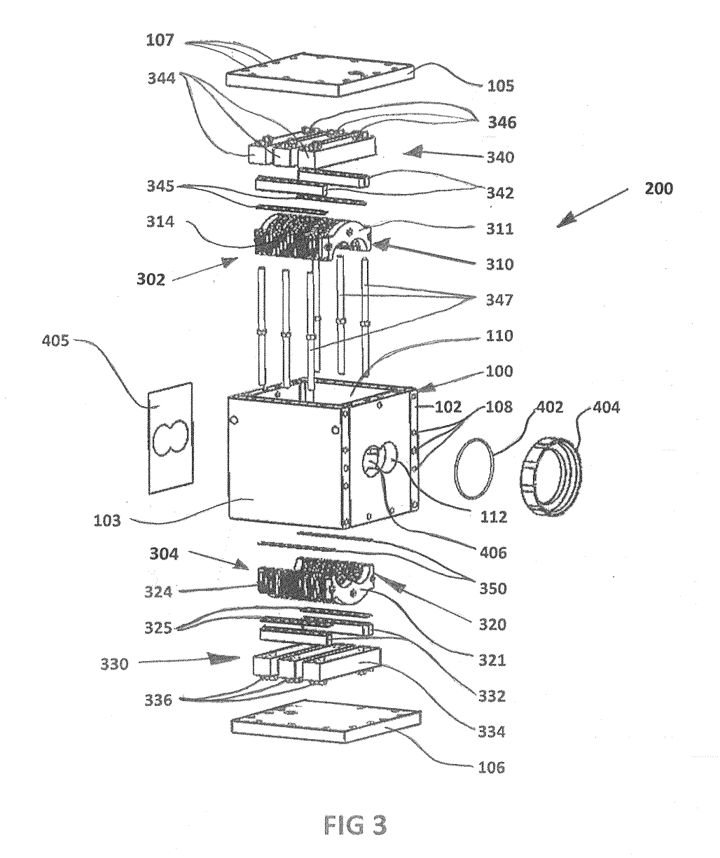

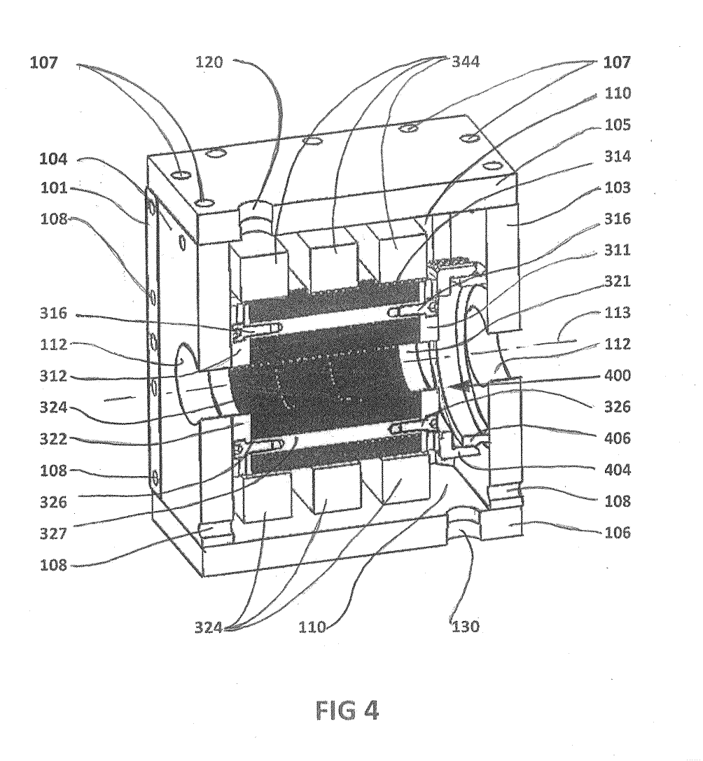

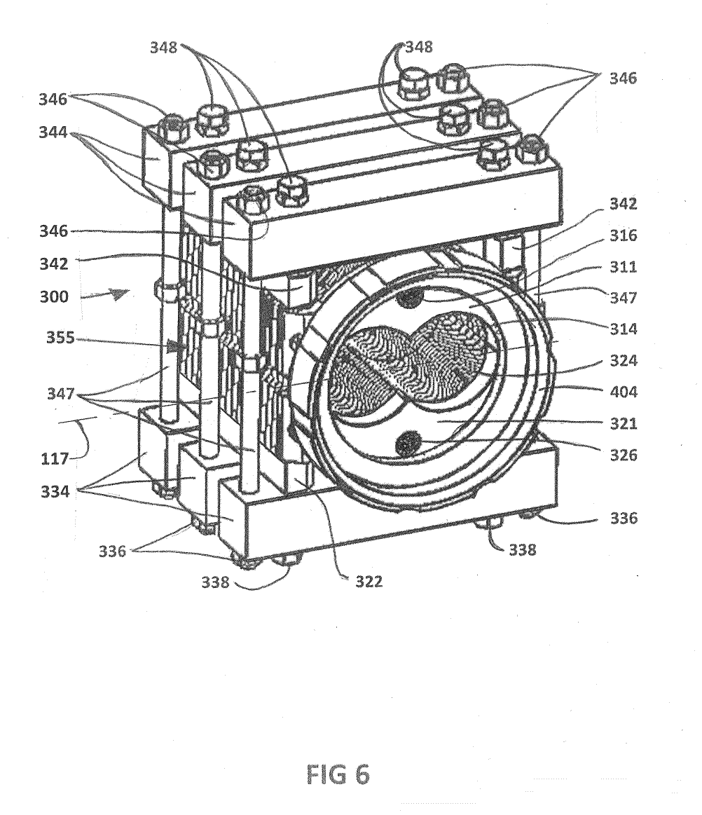

A perspective view of an exemplary solid/fluid separation module 200 in accordance with the invention is shown in isolation in FIG. 2. The separation module 200 includes a housing 100 and a split block filter unit contained in the housing. The filter unit will be discussed in more detail with reference to FIGS. 3-10. The housing 100 includes left and right side walls 101, 102, front and back walls 103, 104 and top and bottom lids 105, 106. The walls 101-104 form a casing which is integratable into the barrel 21 of the separating apparatus 20 through bolts (not shown) engaging threaded blind bores 108 in the front and rear edges of the side walls 101, 102 and in the front and rear walls 103, 104. The housing 100 forms a fluid collection chamber 110 (see FIG. 3), which is capable of withstanding the highest pressure of any component, is used to separate filtered out fluids into gases and liquids, and houses a split block filter unit 300 of the invention (see FIG. 6). The collection chamber 110 can be opened by removal of top and/or bottom lids 105, 106 which are bolted onto the side, front and back walls through bolts (not shown) extending through bores 107. The lids 105, 106 may also be hingedly or otherwise attached to one of the walls 101, 102, 103, 104 of the housing to reduce the risk of the lids being misplaced during assembly or disassembly of the filter block. A top, gas outlet 120 is provided in the top lid 105 for the draining of gases from the collection chamber 110. A bottom, liquid outlet 130 (see FIG. 4) is provided in the bottom lid 106 for the draining of liquids from the collection chamber 110. Front and rear walls 103, 104 include a core opening 112 for accommodating the extruder screws (not shown) of the separating apparatus 20. The high-pressure collection chamber 200 is preferably sealed by sealant (not shown) applied at all locations of mutual contact between the components of the housing 100.

As can be seen from FIG. 3, the separation module 200 includes the housing 100 and a split block filter unit 300 with upper and lower (or first and second) filter blocks 302, 304, respectively constructed in the illustrated exemplary embodiment as plate packs 310 and 320. The filter blocks 302, 304 are joined along a plane of symmetry of the core opening 112 and clamped together by a clamping structure to form a clamped block 355. The clamping structure includes upper and lower clamping arrangements 340 and 330 to form the split block filter unit 300. In accordance with a key aspect of the present invention, the split block filter unit 300 can be installed into and disassembled from the housing 100 while the housing is integrated into the extruder barrel 21 (FIG. 1) and while an extruder screw extends, or extruder screws extend, through the extruder barrel. This is best understood from FIGS. 3-6.

For removal of the split block filter unit 300, upper and lower lids 105, 106 are removed to provide access to the split block filter unit 300. The filter unit sealing arrangement 400 (FIG. 4) is loosened to unlock the filter unit 300 in the housing. Then, the upper and lower clamping arrangements 340 and 330 are loosened and the bottom clamping arrangement is disconnected from the connecting rods 347. Once disconnected, the bottom clamping arrangement 330 will fall out of the housing 100 together with the lower filter block 304, here the plate pack 320. The upper clamping arrangement 340, the upper filter block 302, here the plate pack 310, and connecting rods 347 remain seated in the housing, supported by the extruder screws (not shown). Removal of the upper clamping arrangement 340 and the connecting rods 347 upward from the housing 100 will allow access to the upper filter block 302, here the plate pack 310, which can then also be removed from the housing. The upper and lower filter blocks 302, 304 in the form of plate packs 310, 320 can then be disassembled, cleaned, reassembled and reinstalled, or simply replaced. Assembly of the filter unit 300 about the extruder screws and in the housing will occur in reverse order, starting with the upper filter block 302. During assembly, a pair of seals 350 is positioned between the filter blocks 302, 304 for sealing of the filter blocks about the extruder screws to seal the core passage 112 from the collection chamber 110.

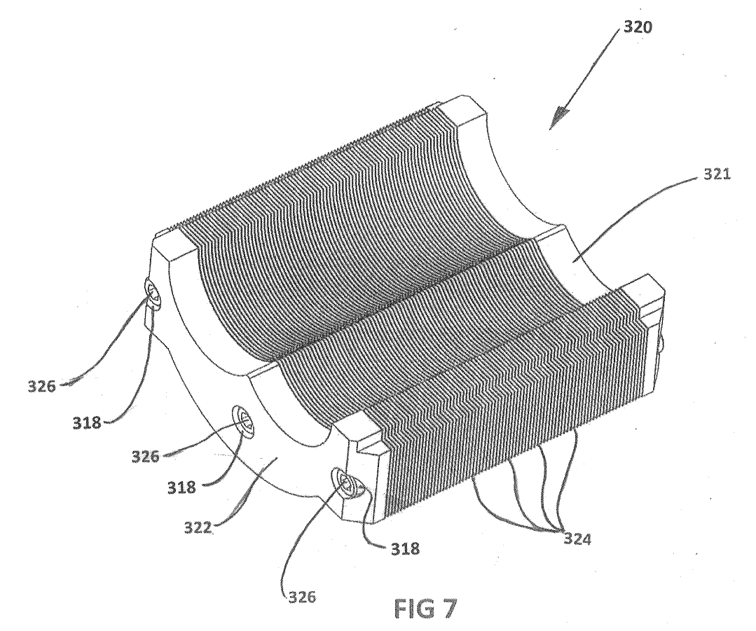

The upper and lower filter blocks 302, 304 can each independently be a solid block, a solid block with drilled filtering passages, or a stacked block as discussed in more detail below in relation to FIGS. 7-9, as long as at least one of the filter blocks includes at least one filtering passage. In the exemplary embodiment illustrated in FIGS. 1-6, both filter blocks 302, 304 are stacked blocks 310, 320, as will be discussed in more detail below.

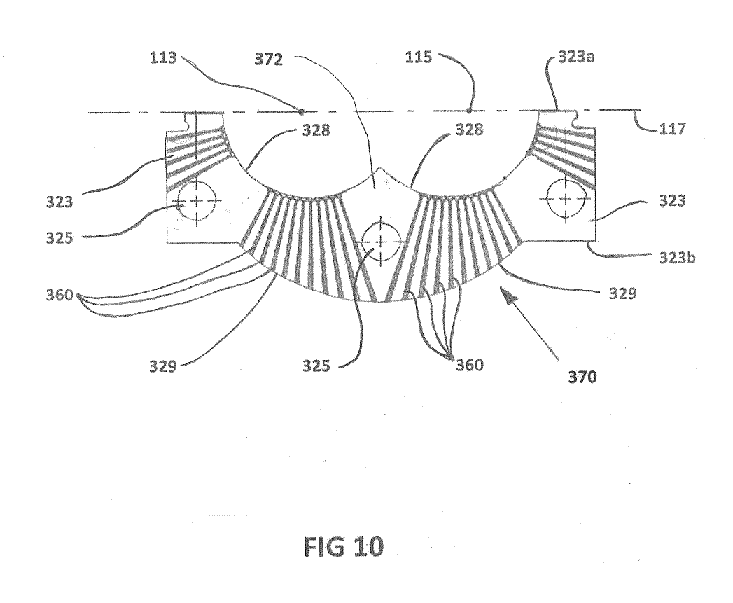

The upper and lower clamping arrangements 340, 330 of the clamping structure as illustrated in detail in FIGS. 3 and 6, each include two or more parallel clamping bars 344, 334, which are spaced apart to allow the passage therebetween of fluids separated by the filter unit 300. The clamping bars 344, 334 are maintained in a fixed, spaced apart relationship by bridging bars 342, 332 to which the clamping bars are bolted by bolts 348, 338 (FIG. 6) and which rest against a pair of lateral clamping shoulders of the stacked blocks formed by the clamping edges 323b (FIG. 10) of the barrel plates and end plates in the stacked block. The upper and lower clamping arrangements 340, 330 are connected with one another about the extruder screws and filter blocks 302, 304 to allow for the clamping of the filter blocks against one another, thereby sealing the filter blocks about the extruder screws. The upper and lower clamping arrangements 340, 330 are connected by way of connecting rods 347 which extend past the filter blocks 302, 304. The upper and lower clamping bars 344, 334 are bolted to the connecting rods by bolts 346, 336 (FIGS. 3 and 6). The assembly of the upper and lower clamping arrangements 340, 330 as described includes separate clamping bars 344, 334 and bridging bars 342, 332. This construction provides a modular approach, allowing longitudinal elongation or shortening of the clamping arrangements by simply adding or removing clamping bars and using longer or shorter bridging bars. In the alternative, the upper and lower clamping arrangements 340, 330 can respectively made in one piece.

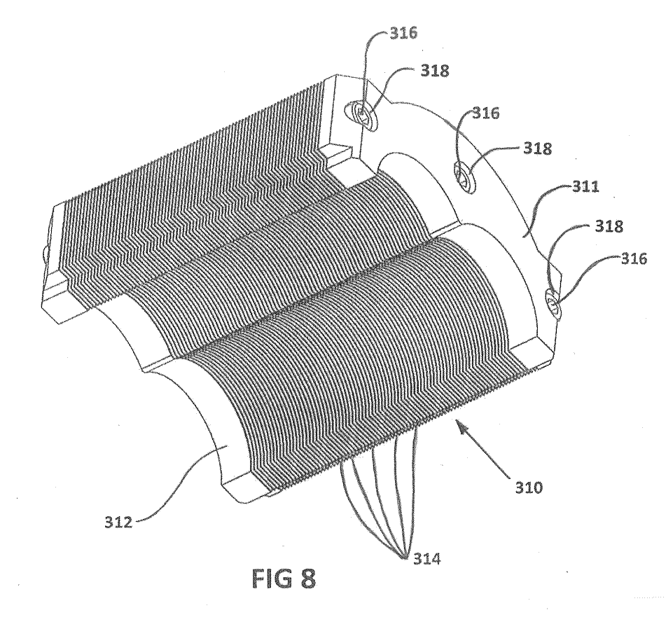

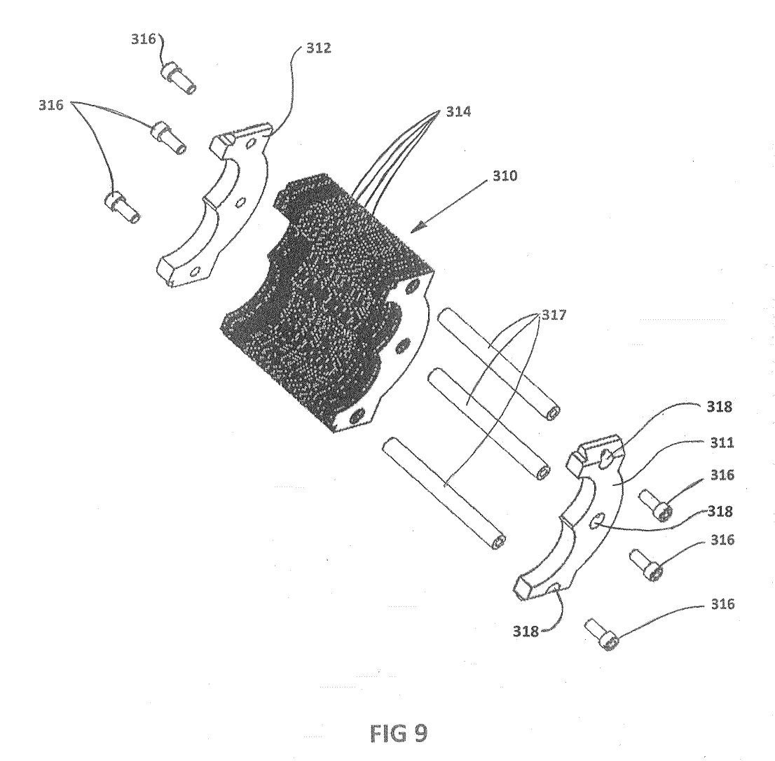

The upper and lower stacked blocks 310, 320 as illustrated in separation in FIGS. 8 and 7, are assembled from barrel plates 314, 324, end plates and a stacking structure. The end plates include front end plates 311, 321 and back end plates 312, 322. The stacking structure includes alignment rods 317 and alignment bolts 316. The barrel plates 314, 324 include alignment bores 325 for the alignment rods 317 as shown in FIG. 9. In the exemplary embodiment of an upper stacked block 310 as shown in FIG. 9, a plurality of barrel plates 314 are compressed between front and back plates 311, 312 having the same basic overall outline as the barrel plates 314 but being much thicker for even compression of the plate pack. The front and back end plates 311, 312 include the same alignment bores 325 as the barrel plates 314 and recesses 318 for the bolts 316. The alignment rods 317 in combination with clamping bolts 316 recessed into the front and back end plates 311, 312 are used to clamp the plate pack between the end plates 311, 312 to seal the barrel plates 314 together and form the upper stacked block 310. The lower stacked block 320 is assembled in an identical manner using barrel plates 324, front and back end plates 321, 322, the alignment rods 317 and alignment bolts 316, whereby the barrel plates 324 and end plates 321, 322, are shaped mirror image to the barrel plates 314 and end plates 311, 312.

Other arrangements for holding the barrel plates aligned and compressed in a plate stack can also be used. The alignment structure can also be integrated with the associated clamping arrangement (not shown) to allow handling of the upper and lower filter blocks 310, 320 together with the respectively associated clamping arrangement, thereby possibly facilitating insertion into and removal from the housing. One or more of the barrel plates 314, 324 in the upper and lower stacked blocks 310, 320 can be constructed as a filter plate. The detailed construction of those barrel plates 314, 324 which are constructed as filter plates will be discussed in more detail below in reference to FIG. 10.

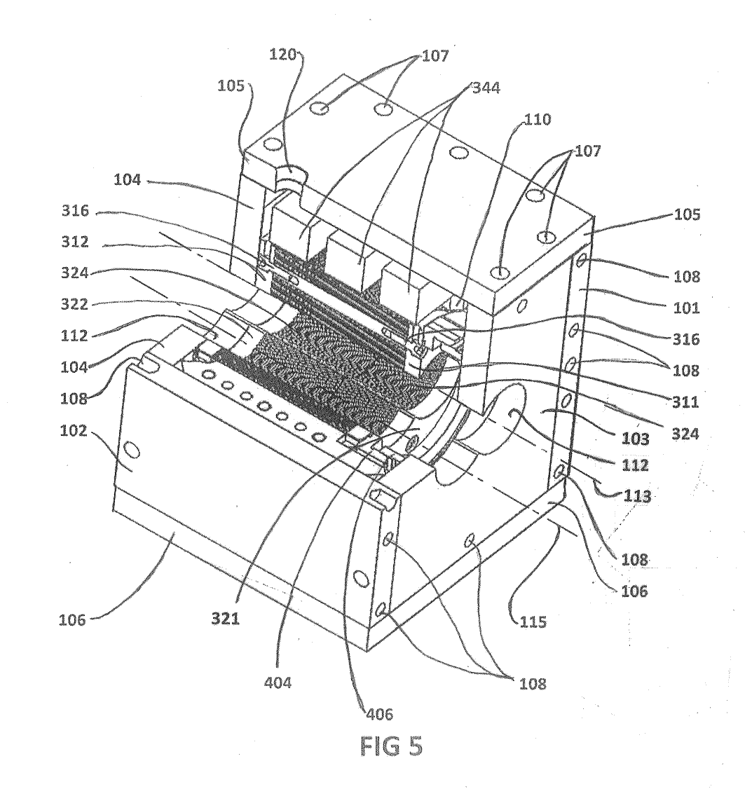

Turning now to FIGS. 3 to 6, the locking arrangement 400 functions to lock the clamped block 355 in the housing 100 between the front and back walls 101, 102 and seal the collection chamber 110 from the throughgoing core passage 112 within the clamped block 355. The locking arrangement 400 includes an externally threaded cylindrical base sleeve 406 attached to, or integrated into, one of the front and back walls 101, 102 in concentric alignment with the core passage 112, a threaded cap nut 404 threadedly engageable with the base sleeve, a circular seal 402 for placement between the cap nut 404 and the clamped block 355 and a flat seal 405 for placement between the clamped block 355 and the other of the front and back walls 101, 102 to which the base sleeve 406 is not attached. Threading of the cap nut 404 onto the base sleeve 406 increases the spacing between the cap nut and the opposing end wall of the housing 100, while unthreading decreases this spacing. Thus, the cap nut 404 is fully threaded onto the base sleeve 406 for installation and removal of the clamped block 355 of the filter unit 300. For sealing of the filter unit 300 in the housing, the cap nut 404 is unthreaded until the clamped block is tightly pressed between the cap nut 404 and the opposing end wall of the housing (see FIGS. 4 and 5). Although the use of a rotatable locking arrangement as illustrated in FIGS. 3 to 6 provides for an easy locking and unlocking of the clamped block within the housing, any other locking structure useful for reliably locking the clamped block in the housing while sealing the core passage from the collection chamber can be used. For example, a pair of opposing wedges (not illustrated) with an opening or slot for accommodating the core opening may be used, in place of the base sleeve 406 and cap nut 404, to wedge the clamped block in the housing. One of the wedges can be attached to, or integrated into one of the front and back walls 101, 102 for ease of locking and unlocking.

As illustrated in FIGS. 4, 5 and 7-9, the filter unit includes stacked barrel plates 314, 324 which, when stacked and clamped in the filter unit 300, define a portion of the core passage 112 extending through the barrel 21 of the separating apparatus 20. The core passage 112 has one, two or more longitudinal axes, equal in number to the number of extruder screws housed in the core passage. Filter blocks made of stacked barrel plates have been disclosed in U.S. Application US 2012/0118517. However, the filter and backer plates disclosed in this prior filter system are continuous about the core opening and therefore cannot be removed from around the conveyor screw, but must be pulled off the conveyor screw, or disassembled from the filter press once the conveyor screw has been removed. To enable removal of the stacked barrel plates from the housing without removal of the extruder screws, the filter unit in accordance with the invention includes a split filter block. This can be achieved either by splitting the conventional full barrel plates into first and second halves along a plane of symmetry extending through each longitudinal axis of the core opening 112, or by building separate split block halves from barrel plates designed to form half of the core opening. The latter approach is more advantageous, since it allows for the simplification of the barrel plates and the stacked block structure, as will be discussed below. The barrel plates can be divided along the plane of symmetry 117 of the core opening 112, which plane extends through the two longitudinal axes 113, 115 into upper split plates 314 and lower split plates 324 (FIG. 6). Alternatively, rather than splitting full plates, separate upper and lower barrel plates 314, 324 can be separately produced, which barrel plates can be different in design, or of mirror image design as shown in FIGS. 7 and 8. Making the upper and lower barrel plates of mirror image design makes is possible to use a single type of universal filter plate 370 as shown in FIG. 10, which can be used for both the upper and lower barrel plate packs 310, 320. The single design, universal barrel plate 370 includes a body 372 with flat front and rear faces, an inner edge 328 extending between the front and rear surfaces, an outer edge 329 extending between the front and rear surfaces and lateral tabs 323. The inner edge 328 defines exactly one half of the central core opening 112 located to one side of the plane of symmetry 117. The outer edge 329 is for contact with the collection chamber 110 (FIG. 3) and is convexly curved to maintain a minimum body width between the inner and outer edges 328, 329. The lateral tabs 323 are provided for clamping of the universal barrel plate 370, when part of a stacked block, along the plane of symmetry 117 against the stacked barrel plates of a like stacked block. The universal barrel plates 370 when stacked in a stacked block each include a sealing edge 323a extending in the plane of symmetry 117 for engagement with the sealing edge of a like universal barrel plate 370 placed in mirror image on the opposite side of the plane of symmetry. The lateral tabs 323 each further include a clamping edge 323b extending parallel to the sealing edge 323a for engagement by one of the bridging bars 342, 332 (FIG. 3). The clamping edges 323b of the barrel plates 370 in a plate stack together form a clamping shoulder for engagement by one of the bridging bars 342, 332 of the upper and lower clamping arrangements 340, 330 respectively. The universal barrel plate 370 includes alignment bores 325 for receiving the alignment rods 317 as shown in FIG. 9. In the exemplary embodiment shown in FIG. 9, a plurality of universal barrel plates 370 is compressed into the upper stacked block 310 (the lower stacked block 320 being identical and simply used upside down) by the front and back end plates 311, 312. The alignment rods 317 in combination with clamping bolts 316 are used to clamp the plate pack between the end plates to seal the barrel plates 370 together and form the stacked block 310, 320.

In order to achieve a separation of fluids from a pressurized fluid/solids mixture in the core opening 112, one or more of the universal barrel plates 370 in the stacked block 310, 320 can be constructed as a filter plate 372 including one or more filter passages 360 which each define a fluid passage in the filter plate 372 extending away from the inner edge 328. The filter passage 360 may extend all the way from the inner edge 328 to the outer edge 329 or from the inner edge 328 to a location away from the core opening at which it connects with another fluid passage either provided on or in the same plate or on/in a directly adjacent plate for fluid communication with the collection chamber. The filter passages 360 can be provided by cutting, scoring, etching or bending of the barrel plates 314, 324, 370 and the exact manner in which the passage is created will not be further discussed herein, since not of particular significance to the present invention. If the filter passage 360 extends from the inner edge 328 to the outer edge 329 in the front surface of the filter plate, only one type of filter plate is needed, since when this filter plate is stacked one behind the other with other like filter plates, the back surface of one filter plate will always function as a cover for the filter passage 360 in the like filter plate immediately behind. If a first section of the filter passage extending away from the inner edge is provided in one barrel plate and a complementary fluid passage connecting the first section with the outer edge is provided in another barrel plate, those two types of plates will allways have to be used as plate pairs in the stacked block.

In one embodiment, each barrel plate 314, 324, or universal barrel plate 370, is constructed as a filter plate to simplify the filter unit design and to maximize the filtering capacity of the filter unit. To maximize the porosity of a stacked block, each filter plate includes the maximum number of filter passages 360 which can be included in the filter plate without harming the structural integrity and pressure retention capacity of the filter plate and of the stacked block in which it is included. To reduce manufacturing cost and facilitate assembly, all barrel plates used in the separating module 200 can be filter plates 372 of identical construction.

The number of barrel plates 314, 324 included in the separating module 200 can be adjusted according to the plate thickness, the dimensions of the housing 100 and the desired filter porosity. In the illustrated embodiment, each stacked block 310, 320 included 200 filter plates 372 per inch of stacked length, each plate being 0.005 inch thick and having an overall open area of 0.864 square inches. With the illustrated embodiment, a dry matter content of 72% can be achieved at barrel pressures of about 600 psig. On a continuous basis, 100 g of biomass containing 40 g of solids and 60 g of water can be squeezed out in the filter module 300 using 600 psig internal force at a temperature of 100 C to obtain a dry biomass discharge (solids portion of the liquid/solid biomass) containing 39 g of suspended solids and 15 g of water. The filtrate obtained will contain about 95 g of water, which will be relatively clean and contain only a small amount (about 1 g) of suspended solids with a mean particle size equal to the pore size of the filter passages 360.

In the illustrated embodiment of the universal filter plate 372 of FIG. 10, the filter passages 360 are in the form of a recess cut to a depth, which is only a fraction of the filter plate thickness, to minimize the effect of the recess on the structural integrity of the plate and to prevent warping or buckling of the plate during installation or operation as much as possible. Preferably, the recess has a depth, which is at most ⅓ of the plate thickness, more preferably ⅕ of the plate thickness, most preferably at most 1/10 of the plate thickness. Very small filter pores can be achieved in this manner by using very thin filter plates and very shallow recesses. For example, by cutting filter passages 360 of 0.05 inch width and 0.001 inch depth into the filter plate 372, a pore size of only 0.00005 square inch can be achieved. For even finer filtering, filter passages of 0.01 inch width can be used. The filter passage 360 can be produced, for example, by laser cutting or acid etching. In the illustrated exemplary embodiment, the filter plates 372 were made of 316 Stainless Steel and the passages 360 were cut by acid etching. A conventional photo lithography process can be used to define on the filter plate 372 the shape and pattern of the passages to be cut.

The principle construction of assembling a portion of the barrel 21 from stacked identical barrel plates, which may be constructed as filter plates, allows for significant design variability and even enables the variation of the filtering or separation capacity and behavior of an extruder press by not only varying the filtering capacity of individual separating modules 200, but by converting separating modules 200 into barrel modules 12 by simply replacing the stacked blocks 310, 320 including one or more filtering plates with stacked blocks including only barrel plates and no filter plates, or even blocks of overall solid construction. In one possible embodiment, the complete barrel is constructed using separating modules, some of which have been converted to barrel modules 12 by replacement of the filter plates in the stacked blocks 310, 320 with barrel plates, In another embodiment, each separating module includes a solid filter block and a stacked filter block, whereby the solid block forms the upper filter block of the filter unit and the stacked block forms the lower filter block. It is a significant advantage of an arrangement in which each barrel module is a separating module in accordance with the invention that any part of the barrel can be used as a barrel section or as a filter unit and can be converted from one to the other without requiring disassembly of the barrel, by simply exchanging the filter blocks. Each of the filter blocks along the barrel can be a solid filter blocks, or a stacked block with a particularly selected porosity. Separation modules in which the upper and lower filter blocks are both solid blocks or stacked blocks devoid of any filter passage then function as a regular barrel module 12. Moreover, it is another significant advantage of such an arrangement that a blockage in any part of the barrel, whether in a separating/filtering region or not, can be cleared, without the need for disassembly of the extruder press or removal of the conveyor screws, by simply replacing the clogged filter block with a clean like filter block and/or removing the compacted solids surrounding the conveyor screws and blocking the core passage 112.

Overall, with higher pressure capability, either more liquid can be squeezed from the solids or, for the same material dryness, a higher production rate can be achieved per unit filtration area. The quality of filtration (solids capture) can be controlled depending on plate configurations and thicknesses. The filtration/pressure rating/capital cost can be optimized depending on the filtration requirements of the particular biomass. The plate configurations can be installed in an extruder (single, twin or triple screws) to develop high pressure, high throughput, continuous separation. The solid/fluid separation module can be constructed with sufficiently tight spacing between the conveyor screws themselves and between the conveyor screws and the inner edge to achieve a self-cleaning effect (for twin and triple screws) by a wiping action of the screws and by an cross axial flow pattern. The filtration area is flexible depending on process requirements as the length of plate pack can be easily custom fit for the particular requirements. The module can be used to wash solids in a co current or counter current configuration in single or multiple stages in one machine reducing capital cost and energy requirements. The pressure of the liquid filtrate can be controlled from vacuum conditions to even higher than the filter block internal pressure (2,000 to 3,000 psig), if required. This provides great process flexibility for further separations in the liquid stream (example super critical CO2 under high pressure, ammonia liquid used for washing under high pressure, or release of VOC and ammonia gases in the liquid filtrate chamber using vacuum).

In the exemplary solid/fluid separation device described, the screw elements that transfer the material internally in the separation device have very close tolerances to the internal surface of the filter block and continually scrape the material away from the filter surface. In the event that a small amount of fibers became trapped on the surface of the filter, they will be sheared by the extruder elements into smaller pieces and ultimately pass through the filter and out with the liquid stream. The high back pressure capability of the housing (higher than internal filter block pressure) can be used to back flush the filter during operation in case of plugging or scaling of the filter, minimizing down time. Of course, any plugging which cannot be cleared by backwashing can be removed by disassembly of only the filter unit 300 which is plugged, without removal of the whole separation module 200 from the separating apparatus 20 or removal of the extruder screws.

It will be readily understood that the solid/fluid separation module in accordance with the invention can be used in many different applications to separate solid/fluid portions of a solid/fluid mixture.

Different filter units 100 have been made and tested. In one embodiment, the filter unit 100 included filter pores having a pore size of 0.00005 square inch for the separation of fine solids, had a porosity of 5.7% and had a pressure resistance of 2,500 psig. In another embodiment, the filter unit 100 included filter pores having a pore size of 0.005 square inch and had a porosity of 20% and a pressure resistance of 5,000 psig. In a further embodiment, the filter unit 100 included filter pores of a pore size of 0.00005 square inch and had a porosity of 11.4%. In still another embodiment, the filter unit 100 included filter pores having a pore size of 0.005 square inch and had a porosity of 20%.

The total number of filter plates can vary depending on the type of solid/fluid mixture to be separated, for example biomass, and influences the overall filter area. For the same liquid separation conditions, more plates/more surface area is required for smaller pores. The size of the pores controls the amount of solids which pass to the liquid portion. Each solid/fluid mixture may require a certain pore size to achieve an optimal solids capture (amount of suspended solids in liquid filtrate). By using separation modules in accordance with the invention, the porosity, pore size, total filter area and pressure capacity of the solid/fluid separation device can be varied and adjusted without disassembly of the device or removal of the conveyor screws, making it possible to adjust the separating properties of the separating device ‘on the fly’.

Although this disclosure has described and illustrated by way of certain embodiments, it is also to be understood that the system, apparatus and method described is not restricted to these particular embodiments. Rather, it is understood that all embodiments, which are functional or mechanical equivalents of the specific embodiments and features that have been described and illustrated herein are included. It will be understood that, although various features have been described with respect to one or another of the embodiments, the various features and embodiments may be combined or used in conjunction with other features and embodiments as described and illustrated herein.

What is claimed is:

1. A filter unit for a solid/fluid separating press, the press having at least one conveyor screw for conveying a solid/fluid mixture and a barrel divided into at least two barrel modules respectively defining a longitudinal portion of a core passage for housing the at least one conveyor screw, at least one of the barrel modules being a filter module having a housing defining a fluid collection chamber, the filter unit comprising
first and second filter blocks joinable along a longitudinal plane of symmetry of the core passage for defining the core passage when joined along the plane of symmetry, the filter blocks being sealably mountable in the housing for the housing and joined filter sections together defining the longitudinal portion of the core passage;
at least one of the filter blocks being a stacked block including a plurality of barrel plates having flat front and back surfaces, an inner edge located at the core opening and an outer edge for contact with the collection chamber, the barrel plates being sealingly stacked in a plate stack one behind the other; and
at least one of the filter blocks including a filter passage extending from the inner edge to the outer edge.

2. The filter unit of claim 1, wherein at least one of the barrel plates is constructed as a filter plate and includes the filter passage.

3. The filter unit of claim 2, wherein the filter passage is in the front and/or back surface.

4. The filter unit of claim 1, wherein at least one pair of the barrel plates is constructed as a filter plate pair defining the filter passage.

5. The filter unit of claim 1 for use with a separating press including two conveyor screws, wherein the plane of symmetry of the core passage extends through a longitudinal axis of each conveyor screw.

6. The filter unit of claim 5, wherein the first filter block is a solid block and the second filter block is a stacked block, or both filter blocks are stacked blocks.

7. The filter unit of claim 6, wherein in each stacked block the plate stack is compressed between a pair of end plates.

8. The filter unit of claim 7, wherein each stacked block includes a stacking structure for aligning the barrel plates in the plate stack and for compressing the plate stack into a filter block wherein the barrel plates are stacked one behind the other.

9. The filter unit of claim 8, further comprising a clamping structure for clamping the first and second filter blocks together along the plane of symmetry to form a clamped block defining a portion of the core passage.

10. The filter unit of claim 9, wherein each filter plate, or filter plate pair, includes a plurality of the filter passages.

11. The filter unit of claim 10, wherein each filter plate, or filter plate pair, has a preselected pore size and each filter passage has an opening area at the inner edge corresponding to the preselected pore size.

12. The filter unit of claim 10, wherein each filter block has a preselected filter pore size and a preselected porosity, each filter passage having an opening area at the inner edge corresponding to the preselected pore size and each filter plate, or filter plate pair having a plate porosity calculated from a total surface of the core opening, the preselected pore size and the number of filter passages, the plate stack including a number of filter plates, or filter plate pairs at least equal to the ratio of preselected porosity/plate porosity.

13. A filter unit for a solid/fluid separating press, the press having at least one conveyor screw for conveying a solid/fluid mixture and a barrel divided into at least two barrel modules respectively defining a longitudinal portion of a core passage for housing the at least one conveyor screw and at least one of the barrel modules being a separating module having a housing defining a fluid collection chamber, the filter unit comprising
a plurality of barrel plates having flat front and back surfaces, an inner edge defining a core opening substantially equal in size and shape to the core passage and an outer edge, each barrel plate being divided into first and second split plates along a plane of symmetry of the core passage;
a stacking structure for aligning the first split plates into a first plate stack and the second split plates into a second plate stack, wherein the first and second split plates are stacked one behind the other in the first and second plate stack respectively, and for compressing the first and second plate stacks into first and second filter blocks wherein the first and second split plates are sealingly engaged with one another in their respective plate stack, and
a clamping structure for clamping the first and second filter blocks together along the plane of symmetry to form a clamped block forming a portion of the core passage and a portion of the barrel;
at least one of the first and second split plates in at least one of the first and second plate stacks defining a filter passage extending from the inner edge to the outer edge.

14. A solid/fluid separating module for a solid/fluid separating press, the press including at least one conveyor screw for conveying a solid/fluid mixture and a barrel defining a core passage for the at least one conveyor screw, the core passage having a longitudinal axis for each extruder screw, the separating module comprising
a housing for integration into the extruder barrel and defining a pressurizable fluid collection chamber, the housing including front and back walls each having a core opening for the at least one conveyor screw, and a pair of opposite removable lids; and
a filter unit according to claim 1 sealingly mounted in the housing between the front and back walls for sealing the core passage in the filter unit from the collection chamber.

15. The solid/fluid separating module of claim 14, further comprising a locking structure between the front and back walls and the clamped block for locking the clamped block in the housing between the front and back walls and sealing the core passage from the collection chamber, the locking structure being movable between an open position, wherein the clamped block is loosely positioned between the front and back walls and the filter blocks can be removed from the housing, and a closed position in which the locking structure locks the clamped block between the front and back walls to seal the core passage defined by the clamped block from the collection chamber.

16. A solid/fluid separating press including at least one conveyor screw for conveying a solid/fluid containing mixture and a barrel defining a core passage for the at least one extruder screw, the core passage having a longitudinal axis for each extruder screw, the barrel including at least two barrel modules of which at least one is a solid/fluid separating module as defined in claim 14.

17. The solid/fluid separating press of claim 16, wherein multiple barrel modules are solid/fluid separating modules.

18. The solid/fluid separating press of claim 17, wherein each solid/fluid separating module has a preselected pore size, each filter passage has an opening area at the inner edge corresponding to the preselected pore size and each solid/fluid separating module has a preselected porosity calculated from a total surface of the core opening divided by the preselected pore size and the number of filter passages in the filter blocks.

19. Use of the solid/fluid separating press of claim 16 for separating fluids from a solid/fluid containing mixture.

20. The use of claim 19, wherein the solid/fluid mixture is biomass.
